(19) United States
(12) Patent Application Publication
(10) Pub. No.: US 2012/0202492 A1
(43) Pub. Date: Aug. 9, 2012

(54) METHOD AND APPARATUS FOR ENABLING IDENTIFICATION OF A REJECTING NETWORK IN CONNECTION WITH REGISTRATION AREA UPDATING

(75) Inventor: Matti Moisanen, Oulu (FI)

(73) Assignee: Renesas Mobile Corporation

(21) Appl. No.: 13/020,560

(22) Filed: Feb. 3, 2011

(51) Int. Cl. H04W 60/00

(52) U.S. Cl. 455/435.1

(57) ABSTRACT

A method for enabling identification of a rejecting network in connection with registration area updating may include receiving an indication of a rejection by a network entity of a request for a registration area update procedure provided by a mobile terminal, and causing an information element to be inserted into a reply to the request that indicates the rejection. The information element may indicate an identity of the network corresponding to the network entity. A corresponding apparatus and computer program product are also provided.

### TECHNOLOGICAL FIELD

Embodiments of the present invention relate generally to wireless communication technology and, more particularly, relate to an apparatus, method and computer program product for enabling identification of a rejecting network in connection with registration area updating.

### BACKGROUND

Wireless and mobile networking technologies have been developing at a rapid pace. Driven by consumer demand, and fueled by continuous advances in battery technology and the ability to manufacture small and highly capable devices, many advancements have also been made in relation to the production of devices that utilize these developing technologies. These devices are becoming ubiquitous in the modern world and are increasingly being employed for use in communication, gaming, social networking, content generation, content sharing, scheduling and numerous other activities.

While the numbers of devices in the hands of users continue to increase, and the capabilities of the devices to perform complex functions and communicate with other devices also increase, the networks that support these devices may be put under a strain. In this regard, support for processing functions, communication and content sharing requires reliable communication that can be maintained in an efficient manner. As such, there is a continued need to improve network performance to support the devices that utilize wireless communication networks.

### BRIEF SUMMARY OF EXAMPLE EMBODIMENTS

A method, apparatus and computer program product are therefore provided that may enable identification of a rejecting network in connection with registration area updating. For example, some embodiments may provide a mechanism by which a network that rejects a tracking area update (TAU) procedure triggered by a mobile communication device may be identified to the corresponding mobile communication device. The mobile communication device may then be enabled to add the corresponding network to a list of networks forbidden to the mobile communication device.

In one example embodiment, a method of enabling identification of a rejecting network in connection with registration area updating is provided. The method may include receiving an indication of a rejection by a network entity of a request for a registration area update procedure provided by a mobile terminal, and causing an information element to be inserted into a reply to the request that indicates the rejection. The information element may indicate an identity of the network corresponding to the network entity.

In another example embodiment, an apparatus for enabling identification of a rejecting network in connection with registration area updating is provided. The apparatus may include processing circuitry configured to perform at least receiving an indication of a rejection by a network entity of a request for a registration area update procedure provided by a mobile terminal, and causing an information element to be inserted into a reply to the request that indicates the rejection. The information element may indicate an identity of the network corresponding to the network entity.

In one example embodiment, a computer program product for enabling identification of a rejecting network in connection with registration area updating is provided. The computer program product may include at least one computer-readable storage medium having computer-executable program code instructions stored therein. The computer-executable program code instructions may include program code instructions for receiving an indication of a rejection by a network entity of a request for a registration area update procedure provided by a mobile terminal, and causing an information element to be inserted into a reply to the request that indicates the rejection. The information element may indicate an identity of the network corresponding to the network entity.

In one example embodiment, a method of enabling identification of a rejecting network in connection with registration area updating is provided. The method may include causing communication of a request for a registration area update procedure from a mobile terminal to a network entity, and responsive to receipt of a message indicating a rejection of the request, determining an identity of the network that rejected the request based on an information element inserted into the message.

In another example embodiment, an apparatus for enabling identification of a rejecting network in connection with registration area updating is provided. The apparatus may include processing circuitry configured to perform at least causing communication of a request for a registration area update procedure from a mobile terminal to a network entity, and responsive to receipt of a message indicating a rejection of the request, determining an identity of the network that rejected the request based on an information element inserted into the message.

In one example embodiment, a computer program product for enabling identification of a rejecting network in connection with registration area updating is provided. The computer program product may include at least one computer-readable storage medium having computer-executable program code instructions stored therein. The computer-executable program code instructions may include program code instructions for causing communication of a request for a registration area update procedure from a mobile terminal to a network entity, and responsive to receipt of a message indicating a rejection of the request, determining an identity of the network that rejected the request based on an information element inserted into the message.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates one example of a communication system according to an example embodiment of the present invention;

FIG. 2 illustrates a block diagram showing an apparatus for enabling identification of a rejecting network in connection with registration area updating in accordance with an example embodiment of the present invention;

FIG. 3 illustrates a block diagram showing an apparatus for enabling identification of a rejecting network in connection with registration area updating from the perspective of a mobile terminal in accordance with an example embodiment of the present invention;

FIG. 4 illustrates a flowchart of a method of enabling identification of a rejecting network in connection with registration area updating in accordance with an example embodiment of the present invention; and

FIG. 5 illustrates a flowchart of a method of enabling identification of a rejecting network in connection with registration area updating from the perspective of a mobile terminal in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

A shared radio access network (RAN) is a network configuration in which the access network is shared between several core network operators and in which several public land mobile networks (PLMNs) may be available in one cell. A RAN typically provides an air interface that sits between users and a core network. The users can access the core network (via the RAN) utilizing a user equipment (UE) or other mobile terminal. The Universal Mobile Telecommunications System (UMTS), GSM (Global System for Mobile Communications) EDGE (enhanced data rates for GSM evolution) Radio Access Network (GERAN), and the Evolved UMTS Terrestrial Radio Access Network (EUTRAN) are examples of access networks that may be used to access a core network. Switching between these or other access networks at various times may be permitted or even preferred in some cases to enable users to receive the best service currently available at any given time or location.

In one case, an Evolved Packet System (EPS) UE non-access stratum (NAS) always knows an identity of the current serving PLMN as the identity of the serving PLMN is typically part of the system information (SI). The SI typically includes non access stratum (NAS) and access stratum (AS) information. The AS part includes idle and active mode system information that may be utilized for accessing the network including neighbor radio access technology (RAT) information, neighbor channel information and configuration of terminal measurements to be used in idle and active modes. The NAS part includes, among other parameters, location area (LA), tracking area (TA), PLMN identity (e.g., whether the network is a home or visited network) and PLMN types possible to reach from the serving RAT. The UE typically reads relevant SI of a serving node-B (or other access point), before accessing the system, to optimize the radio access and also to recognize if cell access is restricted by the operator and/or to determine whether the UE has access rights in the cell (e.g., whether the access class of the UE is barred). As such, in a shared RAN, the AS may provide a list of PLMNs that are available in the current cell. The NAS may then choose a serving PLMN from the list of available PLMNs.

Usually, when a handover is performed involving an originating cell and a new cell within a shared RAN, either the serving PLMN or its equivalent PLMN is available in a new cell. Thus, the NAS may select the serving PLMN from the list of available PLMNs as indicated by the AS. However, in some cases, the network may command the UE to perform a handover to a cell where neither the serving PLMN nor an equivalent PLMN is available. In such a case, the UE may trigger a tracking area update (TAU) procedure (e.g., by issuing a TRACKING AREA UPDATE REQUEST) to discover a serving PLMN based on a globally unique temporary identifier (GUTI), which includes a PLMN code. The identity of the serving PLMN may be received by the UE in a TRACKING AREA UPDATE ACCEPT PDU. However, this process requires that the TAU procedure be accepted by the PLMN.

If the TAU procedure is rejected by the network, the UE may not typically be informed as to which PLMN rejected the procedure. The AS may only know the list of PLMNs that are available and may not otherwise have any indication as to which core network operator processed the TAU procedure. In situations where certain TAU rejections are encountered and the identify of a PLMN that is not accessible to the UE is known, an identification of the PLMN, such as a tracking area identification (TAI) code of the PLMN, may be added to a forbidden list in the UE. Thus, in the situation described above where the TAU update procedure is rejected by a PLMN, if the AS (and therefore the UE) can be made aware of the identity of the PLMN that rejected the TAU procedure, the identity of the PLMN may be added to a forbidden list of PLMNs for which the UE is forbidden access. Enabling inaccessible PLMNs to be added to a forbidden list may facilitate transferring of the UE between PLMNs by avoiding situations where the UE's TAU REQUEST is likely to be rejected and delays may be encountered. Accordingly, some example embodiments of the present invention may enable identification of a PLMN that rejects a TAU procedure triggered by a UE.

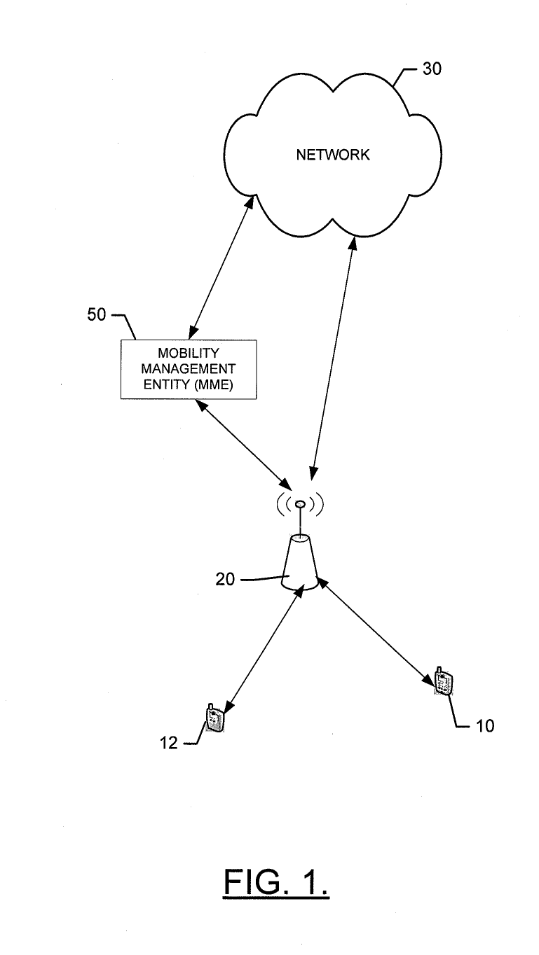

FIG. 1 illustrates a generic system diagram in which a device such as a mobile terminal (or UE 10), is shown in an example communication environment in which embodiments of the present invention may be employed. As shown in FIG. 1, an embodiment of a system in accordance with an example embodiment of the present invention may include a first communication device (e.g., UE 10) and a second communication device 12 that may each be capable of communication with a network 30 (e.g., a core network). The second communication device 12 is provided as an example to illustrate potential multiplicity with respect to instances of other devices that may be included in the network 30 and that may practice example embodiments. The communications devices of the system may be able to communicate with network devices or with each other via the network 30. In some cases, the communication devices may be provided with access to the network via a base station or other communication node 20 (e.g., evolved node B (eNB), node B or other base station). The communication node 20 may have a coverage area that defines a region within which communication devices may utilize the communication node 20 to access the network 30. The communication node 20 may, along with a mobility management entity (MME) 50, be a portion of a radio access network, which in this example may be an EUTRAN. However, it should be understood that example embodiments may be practiced in connection with numerous other networks as well. The MME 50 may also be accompanied by other key entities such as a packet data network gateway and serving gateway, which are not shown in FIG. 1.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the UE 10 and the second communication device 12 may be in communication with each other or other devices via the network 30. In some cases, each of the communication terminals may include an antenna or antennas for transmitting signals to and for receiving signals from a base site (e.g., communication node 20). The base site could be, for example a base station that is a part of one or more cellular or mobile networks or PLMNs. In turn, other devices such as processing devices (e.g., personal computers, server computers or the like) may be coupled to the UE 10 and/or the second communication device 12 via the network 30. In some embodiments, the network 30 may employ one or more mobile access mechanisms such as wideband code division multiple access (W-CDMA), CDMA2000, global system for mobile communications (GSM), general packet radio service (GPRS), long term evolution (LTE), LTE Advanced (LTE-A) and/or the like.

In some example embodiments, the UE 10 (and/or the second communication device 12) may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the UE 10 may include one or more processors that may define processing circuitry either alone or in combination with one or more memories. The processing circuitry may utilize instructions stored in the memory to cause the UE 10 to operate in a particular way or execute specific functionality when the instructions are executed by the one or more processors. The UE 10 may also include communication circuitry and corresponding hardware/software to enable communication with other devices (and/or the network 30 via the communication node 20).

In some embodiments, the MME 50 may include one or more processors that may define processing circuitry either alone or in combination with one or more memories that may store instructions that, when executed by the one or more processors, cause the MME 50 to perform corresponding functions as described herein. In an example embodiment, the MME 50 may be configured to function as a control node responsible for, among other things, enabling an identity of a rejecting PLMN to be provided to the UE 10. The MME 50 may also have involvement in bearer activation and/or deactivation and handling handover functions. NAS signaling may terminate at the MME 50 and the MME 50 may also generate and allocate temporary identities to mobile terminals as appropriate. As such, security key management, ciphering and integrity protection functions may be handled by the MME 50 for NAS signaling. In some embodiments, the MME 50 may be configured to check authorization for mobile terminals to camp in a particular service provider network and enforce roaming restrictions. The MME 50 may also handle additional functionalities and services that are not the subject of this disclosure.

In some situations, where the UE 10 has moved to a different location or for some other reason needs to be handed over to another serving node, the UE 10 may initiate a registration area update (or TAU in LTE systems) by sending a request through its current communication node to its current MME. The current MME may pass information along to the new MME to arrange for the transfer of the UE. After assignment of a mobility management context to the UE 10 in the new tracking area, the new MME may validate the arrival of the UE 10 in the new tracking area and the TAU may be accepted. However, if for some reason, the UE 10 cannot be transferred to a PLMN in the new tracking area, the TAU may be rejected by the new MME. As indicated above, example embodiments may enable the UE 10 to be informed of the identity of the rejecting network in these cases.

Accordingly, in some embodiments, the MME 50 may be configured to determine when certain messages sent by the UE 10 (e.g., messages associated with a registration area update) are rejected and enable identification of the corresponding entity to the UE 10. In an example embodiment, the UE 10 may be configured to send messages, such as PDUs, to trigger or report certain events. As an example, the UE 10 may be configured to send a TRACKING AREA UPDATE REQUEST PDU to trigger a TAU procedure. The MME 50 may enable the UE 10 to be informed of the identity of an entity (e.g., a PLMN) that rejects the request that is sent. As such, the MME 50 may be configured to enable an information element to be provided in a message, such as a TRACKING AREA UPDATE REJECT PDU, that is to be communicated to the UE 10. The information element may contain information identifying the PLMN that rejected the TAU procedure request. Having received the information element, the UE 10 may then take appropriate actions (e.g., adding the PLMN to a forbidden list of PLMNs maintained by the UE 10 that identifies PLMNs that are not accessible to the UE 10).

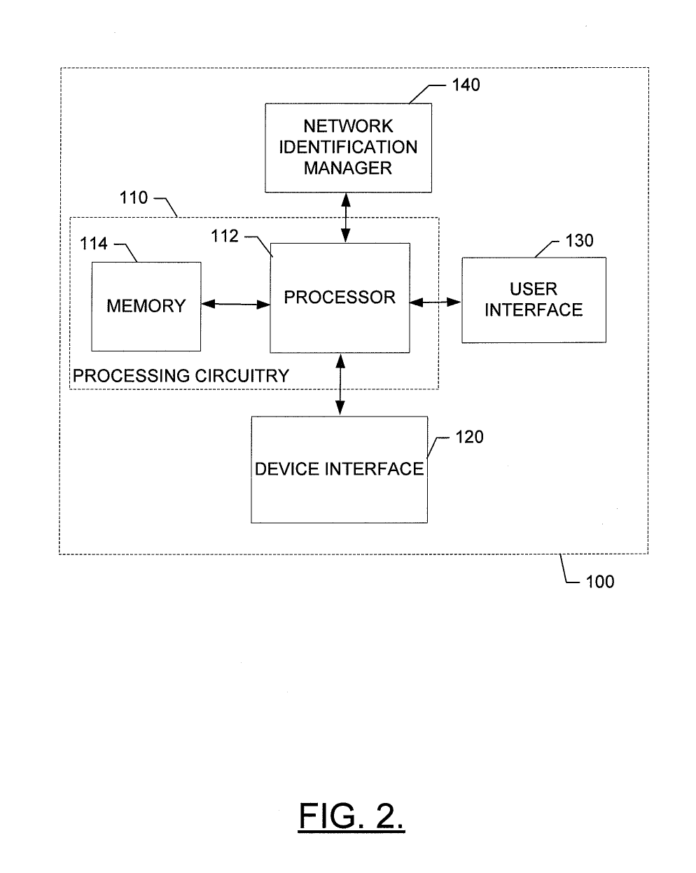

In an example embodiment, the MME 50 may be configured to include or otherwise employ an apparatus configured according to an example embodiment of the present invention. FIG. 2 illustrates a schematic block diagram of such an apparatus for enabling identification of a rejecting network in connection with registration area updating according to an example embodiment of the present invention. An example embodiment of the invention will now be described with reference to FIG. 2, in which certain elements of an apparatus 100 for enabling identification of a rejecting network in connection with registration area updating are displayed. The apparatus 100 of FIG. 2 may be employed, for example, on an MME or a variety of other communication devices. However, it should be noted that the components, devices or elements described below may not be mandatory and thus some may be omitted in certain embodiments. Additionally, some embodiments may include further or different components, devices or elements beyond those shown and described herein.

Referring now to FIG. 2, the apparatus 100 may include or otherwise be in communication with processing circuitry 110 that is configurable to perform actions in accordance with example embodiments described herein. The processing circuitry 110 may be configured to perform data processing, application execution and/or other processing and management services according to an example embodiment of the present invention. In some embodiments, the apparatus 100 or the processing circuitry 110 may be embodied as a chip or chip set. In other words, the apparatus 100 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 100 or the processing circuitry 110 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 110 may include a processor 112 and memory 114 that may be in communication with or otherwise control a device interface 120 and, in some cases, a user interface 130. As such, the processing circuitry 110 may be embodied as a circuit chip (e.g., an integrated circuit chip) configured (e.g., with hardware, software or a combination of hardware and software) to perform operations described herein. However, in some embodiments, the processing circuitry 110 may be embodied as a portion of a server, computer, workstation or other fixed or mobile computing device. In situations where the processing circuitry 110 is embodied as a server or at a remotely located computing device, the user interface 130 may be disposed at another device (e.g., at a computer terminal or client device) that may be in communication with the processing circuitry 110 via the device interface 120 and/or a network (e.g., network 30).

The user interface 130 (if implemented) may be in communication with the processing circuitry 110 to receive an indication of a user input at the user interface 130 and/or to provide an audible, visual, mechanical or other output to the user. As such, the user interface 130 may include, for example, a keyboard, a mouse, a joystick, a display, a touch screen, a microphone, a speaker, and/or other input/output mechanisms. In an exemplary embodiment in which the apparatus is embodied at a server or other network device (e.g., the MME 50), the user interface 130 may be fully implemented, limited, remotely located or eliminated.

The device interface 120 may include one or more interface mechanisms for enabling communication with other devices and/or networks. In some cases, the device interface 120 may be any means such as a device or circuitry embodied in either hardware, or a combination of hardware and software that is configured to receive and/or transmit data from/to a network and/or any other device or module in communication with the processing circuitry 110. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an exemplary embodiment, the memory 114 may include one or more non-transitory memory devices such as, for example, volatile and/or non-volatile memory that may be either fixed or removable. The memory 114 may be configured to store information, data, applications, instructions or the like for enabling the apparatus 100 to carry out various functions in accordance with exemplary embodiments of the present invention. For example, the memory 114 could be configured to buffer input data for processing by the processor 112. Additionally or alternatively, the memory 114 could be configured to store instructions for execution by the processor 112. As yet another alternative, the memory 114 may include one of a plurality of databases that may store a variety of files, contents or data sets. Among the contents of the memory 114, applications may be stored for execution by the processor 112 in order to carry out the functionality associated with each respective application. In some cases, the memory 114 may be in communication with the processor 112 via a bus for passing information among components of the apparatus 100.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform the operations described herein.

In an example embodiment, the processor 112 (or the processing circuitry 110) may be embodied as, include or otherwise control a network identification manager 140. The network identification manager 140 may be configured to access information from various sources and utilize the information to inform the UE 10 in the event that a message is generated by the UE 10 in an effort to trigger a TAU procedure (e.g., via a TRACKING AREA UPDATE REQUEST PDU) and is rejected by a particular PLMN, both that the message was rejected and an identify of the particular PLMN. As such, the network identification manager 140 may be configured to enable insertion, within the response that is provided to the UE 10 to notify the UE 10 of the rejection (e.g., a TRACKING AREA UPDATE REJECT PDU), of the information element indicating an identity of the PLMN that rejected the request. However, in some embodiments, the network identification manager 140 may be configured to send a separate message with the information element.

As such, generally speaking, the network identification manager 140 (e.g., via operation of the processing circuitry 110) may be configured to receive an indication of a rejection by a network entity (e.g., associated with a particular PLMN) of a request for a TAU procedure provided by the UE 10. The network identification manager 140 may then be configured to cause an information element to be inserted into a reply to the request that indicates the rejection. The information element may indicate an identity of the network (e.g., the PLMN) corresponding to the network entity so that the identity of the PLMN may be added to a forbidden list of the UE 10. In some cases, the network identification manager 140 may cause the information element to be inserted into the reply by actually inserting the information element into the reply. However, in an alternative example, the network identification manager 140 may be configured to cause the information element to be inserted into the reply by informing or directing another device (e.g., the communication node 20) to provide the reply to the UE 10 with the information element inserted therein.

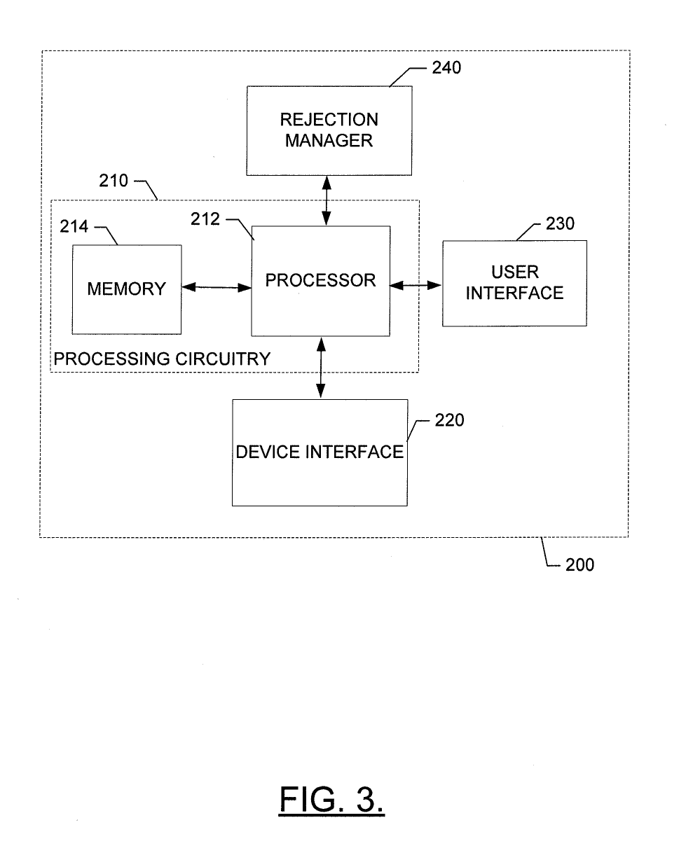

In another example embodiment, the UE 10 may be configured to include or otherwise employ an apparatus according to an example embodiment of the present invention. FIG. 3 illustrates a schematic block diagram of an apparatus for enabling identification of a rejecting network in connection with registration area updating according to an example embodiment of the present invention from the perspective of a UE. An example embodiment of the invention will now be described with reference to FIG. 3, in which certain elements of an apparatus 200 for enabling identification of a rejecting network in connection with registration area updating are displayed. The apparatus 200 of FIG. 3 may be employed, for example, on a UE or a variety of other communication devices. However, it should be noted that the components, devices or elements described below may not be mandatory and thus some may be omitted in certain embodiments. Additionally, some embodiments may include further components, devices or elements beyond those shown and described herein.

Referring now to FIG. 3, the apparatus 200 may include or otherwise be in communication with processing circuitry 210 that is configurable to perform actions in accordance with example embodiments described herein. The processing circuitry 210 may be configured to perform data processing, application execution and/or other processing and management services according to an exemplary embodiment of the present invention. In some embodiments, the apparatus 200 or the processing circuitry 210 may be embodied as a chip or chip set. In other words, the apparatus 200 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include a processor 212 and memory 214 that may be in communication with or otherwise control a device interface 220 and, in some cases, a user interface 230. The processor 212, memory 214, device interface 220 and user interface 230 may be substantially similar in function and basic structure (with perhaps semantic and/or scale differences in some cases) to the descriptions provided above for the processor 112, the memory 114, device interface 120 and user interface 130. Thus, descriptions of these components will not be repeated.

In an exemplary embodiment, the processor 212 (or the processing circuitry 210) may be embodied as, include or otherwise control a rejection manager 240. The rejection manager 240 may be configured to be aware of the communication of a request for a registration area update procedure from the UE 10 to a network entity. Thereafter, the rejection manager may be configured to, responsive to receipt of a message indicating a rejection of the request, determine an identity of the network that rejected the request based on the information element inserted into the message (e.g., by the apparatus 100 of FIG. 2). In some cases, the rejection manager 240 may be further configured to utilize the information element to add the network that rejected the request to a forbidden list of the UE 10.

By employing the procedures described above, the UE 10 may be enabled to be informed of the identity of the PLMN that has rejected its request to initiate a TAU procedure so that the corresponding PLMN may be added to a forbidden list associated with the UE 10. Without the information element, the UE 10 would be unable to know which PLMN (or which part of a PLMN) the UE 10 is not allowed to use. Such lack of knowledge could cause problems by preventing subscribers from using network services in some cases, which may cause the UE 10 to work against 3GPP (Third Generation Partnership Project) specifications. Some example embodiments may be used in connection with wireless modems, mobile terminals or other communication devices to improve system performance.

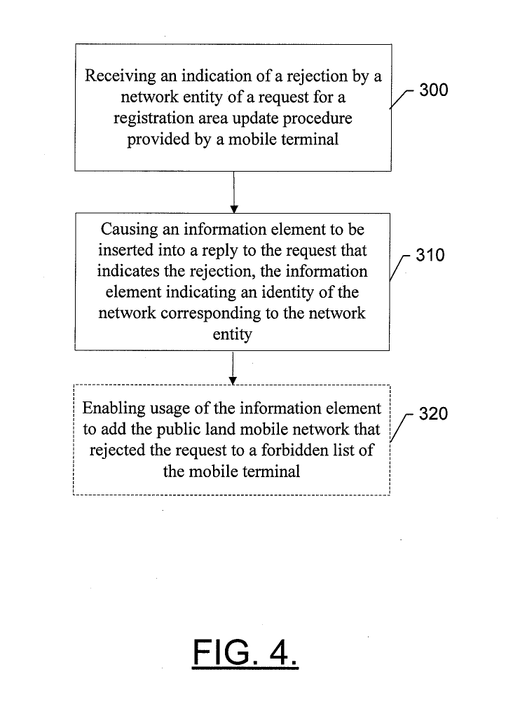

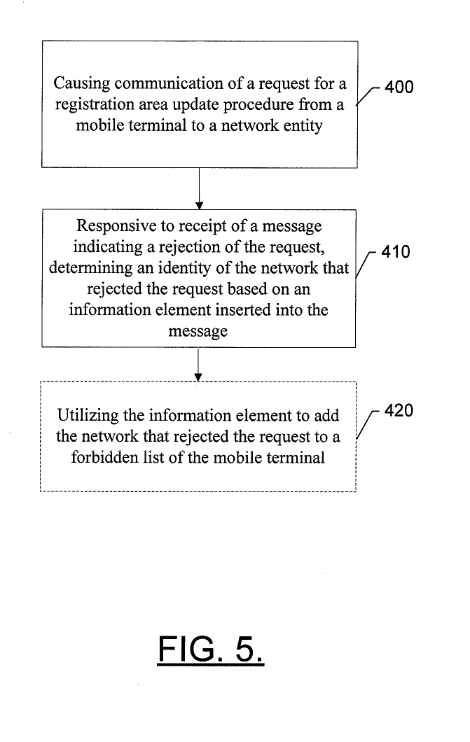

FIGS. 4 and 5 are flowcharts of a system, method and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts block(s). These computer program instructions may also be stored in a non-transitory computer-readable storage memory that may direct a computer or other programmable apparatus to function in a particular manner, such that the instructions stored in the computer-readable storage memory produce an article of manufacture the execution of which implements the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, one embodiment of a method for enabling identification of a rejecting network in connection with registration area updating from the perspective of a network side entity, as shown in FIG. 4, includes receiving an indication of a rejection by a network entity of a request for a registration area update procedure (e.g., a tracking area update (TAU) procedure in LTE) provided by a mobile terminal (e.g., a UE) at operation 300, and causing an information element to be inserted into a reply to the request that indicates the rejection at operation 310. The information element may indicate an identity of the network corresponding to the network entity.

In some embodiments, certain ones of the operations above may be modified or further amplified as described below. Moreover, in some embodiments additional optional operations may also be included (an example of which is shown in dashed lines in FIG. 4). It should be appreciated that each of the modifications, optional additions or amplifications below may be included with the operations above either alone or in combination with any others among the features described herein. In an example embodiment, the method may further include enabling usage of the information element to add the public land mobile network that rejected the request to a forbidden list of the mobile terminal at operation 320. In an example embodiment, receiving the indication may include receiving an indication of receipt of a TRACKING AREA UPDATE REQUEST PDU. In some cases, receiving the indication may include receiving the indication at a mobility management element. In some embodiments, causing the information element to be inserted into the reply may include causing an identification code of a public land mobile network that rejected the request to be included in the information element. In an example embodiment, causing the identification code of the public land mobile network that rejected the request to be included in the information element may include providing the identification code within a TRACKING AREA UPDATE REJECT PDU that is to be provided to the mobile terminal.

In an example embodiment, an apparatus for performing the method of FIG. 4 above may comprise a processing circuitry (e.g., processing circuitry 110) configured to perform some or each of the operations (300-320) described above, with or without some or all of the modifications described above. The processing circuitry 110 may, for example, be configured to perform the operations (300-320) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-320 may comprise, for example, the network identification manager 140. Additionally or alternatively, at least by virtue of the fact that the processing circuitry 110 may be configured to control or even be embodied as the network identification manager 140, the processing circuitry 110 and/or a device or circuitry for executing instructions or executing an algorithm for processing information as described above may also form example means for performing operations 300-320.

Another embodiment of a method for enabling identification of a rejecting network in connection with registration area updating from the perspective of a mobile terminal, as shown in FIG. 5, includes causing communication of a request for a registration area update procedure (e.g., a tracking area update (TAU) procedure in LTE) from a mobile terminal to a network entity at operation 400 and, responsive to receipt of a message indicating a rejection of the request, determining an identity of the network that rejected the request based on an information element inserted into the message at operation 410.

In some embodiments, certain ones of the operations above may be modified or further amplified as described below. Moreover, in some embodiments additional optional operations may also be included (an example of which is shown in dashed lines in FIG. 5). It should be appreciated that each of the modifications, optional additions or amplifications below may be included with the operations above either alone or in combination with any others among the features described herein. In an example embodiment, the method may further include utilizing the information element to add the network that rejected the request to a forbidden list of the mobile terminal at operation 420. In an example embodiment, causing communication of the request may include causing communication of the request in a TRACKING AREA UPDATE REQUEST PDU. In some embodiments, determining the identity of the network may include extracting an identification code of a public land mobile network that rejected the request from the information element. In some cases, the information element may include the identification code included in a TRACKING AREA UPDATE REJECT PDU.

In an example embodiment, an apparatus for performing the method of FIG. 5 above may comprise a processing circuitry (e.g., processing circuitry 210) configured to perform some or each of the operations (400-420) described above, with or without some or all of the modifications described above. The processing circuitry 210 may, for example, be configured to perform the operations (400-420) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-420 may comprise, for example, the rejection manager 240. Additionally or alternatively, at least by virtue of the fact that the processing circuitry 210 may be configured to control or even be embodied as the rejection manager 240, the processing circuitry 210 and/or a device or circuitry for executing instructions or executing an algorithm for processing information as described above may also form example means for performing operations 400-420.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing communication of a request for a registration area update procedure from a mobile terminal to a network entity; and
responsive to receipt of a message indicating a rejection of the request, determining an identity of the network that rejected the request based on an information element inserted into the message.

2. The method of claim 1, wherein causing communication of the request comprises causing communication of a TRACKING AREA UPDATE REQUEST PDU.

3. The method of claim 1, wherein determining the identity of the network comprises extracting an identification code of a public land mobile network that rejected the request from the information element.

4. The method of claim 3, wherein the information element comprises the identification code included in a TRACKING AREA UPDATE REJECT PDU.

5. The method of claim 1, further comprising utilizing the information element to add the network that rejected the request to a forbidden list of the mobile terminal.

6. An apparatus comprising processing circuitry configured to perform at least:
causing communication of a request for a registration area update procedure from a mobile terminal to a network entity; and
responsive to receipt of a message indicating a rejection of the request, determining an identity of the network that rejected the request based on an information element inserted into the message.

7. The apparatus of claim 6, wherein the processing circuitry being configured to cause communication of the request comprises the processing circuitry being configured to cause communication of a TRACKING AREA UPDATE REQUEST PDU.

8. The apparatus of claim 6, wherein the processing circuitry being configured to determine the identity of the network comprises the processing circuitry being configured to extract an identification code of a public land mobile network that rejected the request from the information element.

9. The apparatus of claim 8, wherein the information element comprises the identification code included in a TRACKING AREA UPDATE REJECT PDU.

10. The apparatus of claim 6, wherein the processing circuitry is further configured to utilize the information element to add the network that rejected the request to a forbidden list of the mobile terminal.

11. A computer program product comprising at least one computer-readable storage medium having computer-executable program code instructions stored therein, the computer-executable program code instructions comprising program code instructions for:
causing communication of a request for a registration area update procedure from a mobile terminal to a network entity; and
responsive to receipt of a message indicating a rejection of the request, determining an identity of the network that rejected the request based on an information element inserted into the message.

12. The computer program product of claim 11, wherein program code instructions for causing communication of the request include instructions for causing communication of a TRACKING AREA UPDATE REQUEST PDU.

13. The computer program product of claim 11, wherein program code instructions for determining the identity of the network include instructions for extracting an identification code of a public land mobile network that rejected the request from the information element.

14. The computer program product of claim 13, wherein the information element comprises the identification code included in a TRACKING AREA UPDATE REJECT PDU.

15. The computer program product of claim 11, further comprising program code instructions for utilizing the information element to add the network that rejected the request to a forbidden list of the mobile terminal.

16. A method comprising:
receiving an indication of a rejection by a network entity of a request for a registration area update procedure provided by a mobile terminal; and
causing an information element to be inserted into a reply to the request that indicates the rejection, the information element indicating an identity of the network corresponding to the network entity.

17. The method of claim 16, wherein receiving the indication comprises receiving an indication of receipt of a TRACKING AREA UPDATE REQUEST PDU.

18. The method of claim 16, wherein causing the information element to be inserted into the reply comprises causing an identification code of a public land mobile network that rejected the request to be included in the information element.

19. The method of claim 18, wherein causing the identification code of the public land mobile network that rejected the request to be included in the information element comprises including the identification code in a TRACKING AREA UPDATE REJECT PDU that is to be provided to the mobile terminal.

20. The method of claim 18, further comprising enabling usage of the information element to add the public land mobile network that rejected the request to a forbidden list of the mobile terminal.

21. An apparatus comprising processing circuitry configured to perform at least:
receiving an indication of a rejection by a network entity of a request for a registration area update procedure provided by a mobile terminal; and
causing an information element to be inserted into a reply to the request that indicates the rejection, the information element indicating an identity of the network corresponding to the network entity.

22. The apparatus of claim 21, wherein the processing circuitry being configured to receive the indication comprises the processing circuitry being configured to receive an indication of receipt of a TRACKING AREA UPDATE REQUEST PDU.

23. The apparatus of claim 21, wherein the processing circuitry being configured to cause the information element to be inserted into the reply comprises the processing circuitry being configured to cause an identification code of a public land mobile network that rejected the request to be included in the information element.

24. The apparatus of claim 23, wherein the processing circuitry being configured to cause the identification code of the public land mobile network that rejected the request to be included in the information element comprises the processing circuitry being configured to include the identification code in a TRACKING AREA UPDATE REJECT PDU that is to be provided to the mobile terminal.

25. The apparatus of claim 23, wherein the processing circuitry is further configured to enable usage of the information element to add the public land mobile network that rejected the request to a forbidden list of the mobile terminal.

26. A computer program product comprising at least one computer-readable storage medium having computer-executable program code instructions stored therein, the computer-executable program code instructions comprising program code instructions for:
receiving an indication of a rejection by a network entity of a request for a registration area update procedure provided by a mobile terminal; and
causing an information element to be inserted into a reply to the request that indicates the rejection, the information element indicating an identity of the network corresponding to the network entity.

27. The computer program product of claim 26, wherein program code instructions for receiving the indication include instructions for receiving an indication of receipt of a TRACKING AREA UPDATE REQUEST PDU.

28. The computer program product of claim 26, wherein program code instructions for causing the information element to be inserted into the reply include instructions for causing an identification code of a public land mobile network that rejected the request to be included in the information element.

29. The computer program product of claim 28, wherein program code instructions for causing the identification code of the public land mobile network that rejected the request to be included in the information element include instructions for including the identification code in a TRACKING AREA UPDATE REJECT PDU that is to be provided to the mobile terminal.

30. The computer program product of claim 28, further comprising program code instructions for enabling usage of the information element to add the public land mobile network that rejected the request to a forbidden list of the mobile terminal.
